(19) United States
(12) Patent Application Publication
(10) Pub. No.: US 2013/0212994 A1
(43) Pub. Date: Aug. 22, 2013

(54) LAWN MOWER ROBOT AND METHOD OF CONTROLLING THE SAME

(71) Applicants: Geunbae Hwang, Seoul (KR); Jongjin Woo, Seoul (KR); Dongkyun Nam, Seoul (KR)

(72) Inventors: Geunbae Hwang, Seoul (KR); Jongjin Woo, Seoul (KR); Dongkyun Nam, Seoul (KR)

(73) Assignee: LG ELECTRONICS INC., Seoul (KR)

(21) Appl. No.: 13/592,916

(22) Filed: Aug. 23, 2012

(30) Foreign Application Priority Data
Aug. 3, 2011 (KR) 10-2011-0077456

(51) Int. Cl. A01D 34/00

(52) U.S. Cl. CPC A01D 34/008; Y10S 901/01
USPC 56/10.2 A; 901/1

(57) ABSTRACT

The present embodiment relates to a lawn mower robot. The lawn mower robot includes a body disposed with a moving device; a mowing device disposed in the bottom of the body and mowing lawns; a sensor disposed in the body and outputting data by sensing colors; and a controller determining a lawn presence region based on data output from the sensor.

### CROSS-REFERENCE TO RELATED APPLICATIONS

The present application claims priority under 35 U.S.C. 119 and 35 U.S.C. 365 to Korean Patent Application No. 10-2011-0077456 (filed on Aug. 3, 2011), which is hereby incorporated by reference in its entirety.

### BACKGROUND

The present disclosure relates to a lawn mower robot and a method of controlling the same.

A lawn mower is an apparatus for mowing lawns planted in a home's yard or playground and the like. Such a lawn mower may be classified into a type used at home, and a tractor type used in a wide playground and farm.

The lawn mower for the home is classified into a walk behind type for mowing the lawn while directly dragging the lawn mower from behind, and a directly hand carrying type.

However, there are burdens in that humans should directly operate all of two types of the lawn mower. Particularly, since it is difficult to mow the lawn of a playground by directly operating the lawn mower by an user in today's busy daily life, it is generous to hire outside humans so as to mow the lawns, thereby to generate hiring cost.

### SUMMARY

Embodiments provide a lawn mower robot, and a method of controlling the same.

In one embodiment, a lawn mower robot comprises: a body disposed with a moving device; a mowing device disposed in the bottom of the body and mowing lawns; a sensor disposed in the body and outputting data by sensing colors; and a controller determining a lawn presence region based on data output from the sensor.

In another embodiment, a method of controlling a lawn mower robot comprises: determining a boundary area for determining a lawn presence region based on color information sensed from a sensor on moving the lawn mower robot; determining the lawn presence region based on the determined boundary area when being determined that the lawn mower robot reaches the boundary area to be initially determined on moving the lawn mower robot; and mowing lawns while moving the lawn mower robot in the determined lawn presence region.

The details of one or more embodiments are set forth in the accompanying drawings and the description below. Other features will be apparent from the description and drawings, and from the claims.

### BRIEF DESCRIPTION OF THE DRAWINGS

FIG. 1 is a plan view for a lawn mower robot according to the present embodiment.

FIG. 2 is a block view for a lawn mower robot according to the present embodiment.

FIG. 3 is a view for the lawn mower robot and a lawn presence area G according to the present embodiment.

FIG. 4 is a flow chart for describing a method of controlling the lawn mower robot 1 according to the present embodiment.

### DETAILED DESCRIPTION OF THE EMBODIMENTS

Reference will now be made in detail to the embodiments of the present disclosure, examples of which are illustrated in the accompanying drawings.

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense.

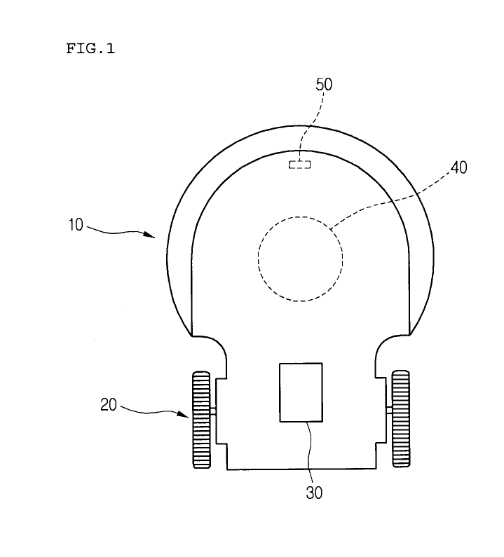

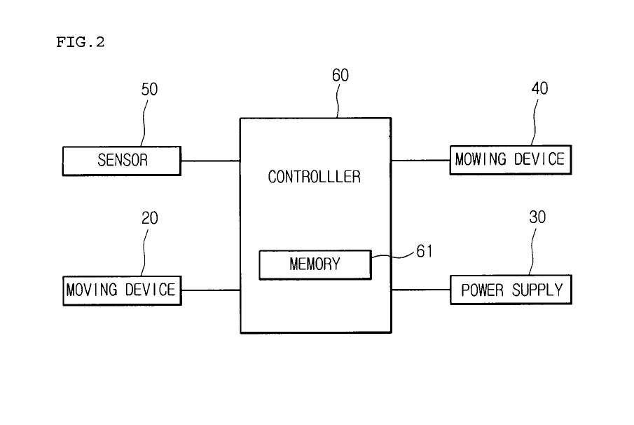

FIG. 1 is a plan view for a lawn mower robot according to the present embodiment, and FIG. 2 is a block view for a lawn mower robot according to the present embodiment.

Referring to FIGS. 1 and 2, the lawn mower robot 1 according to the present embodiment includes a body 10 having a moving device 20 and forming an appearance, a mowing device 40 disposed in a bottom of the body 10 and mowing lawns, a sensor 50 disposed in the body 10 and sensing outside information, a power supply 30 supplying power to the lawn mower robot 1, and a controller 60 disposed in the body 10 and controlling various electronic parts.

The body 10 forms the appearance of the lawn mower robot 1, and various electrical/mechanical parts are received in the inside thereof. The body 10 may be disposed with the power supply 30 for supplying power.

The power supply 30 may be a chargeable and dischargeable battery (second cell). The power supply 30 may be charged by outside power. The power supply 30 may be implemented by a replaceable primary cell, and is connected to the outside through lines to receive commercial power supply.

Hereinafter, although it is described that the power supply 30 is implemented by the second cell, it is not limited thereto.

The power supply 30 is separately coupled with the body 10, or may be detachably connected to a charging device (not shown) to be supplied with outside current. In this case, the charging device is connected to the outside power to supply current, the charging device is interactively communicated with the lawn mower robot 1 such that the lawn mower robot 1 returns to the charging device for oneself to charge the power supply 30.

The moving device 20 may move the lawn mower robot 1. The moving device 20 may include a plurality of wheels, and a plurality of motors for separately driving the plurality of wheels. Rotation velocities of the wheels between the plurality of wheels become different by separately controlling the plurality of motors such that direction switching is possible. Each of the plurality of motors is bidirectional rotating motors. Therefore, the lawn mower robot 10 may move forwarded or backward, or left or right.

The sensor 50 may sense objects in the vicinity of the lawn mower robot 1, and sense humans, animals, stationary objects or moving objects and the like.

The sensor 50 may also sense outside temperature or humidity, sunshine intensity, air volume and the like.

The sensor 50 may sense presence or absence of the lawns. The sensor 50 may be implemented by the sensor for sensing at least one of color, perfume and spectrum of the lawns.

The sensor 50 may include at least one of a mechanical sensor, an optical sensor, a chromatic sensor, a radio frequency sensor, a capacitive sensor, an ultrasonic sensor, an infrared ray sensor, a RGB sensor, a spectrum sensor and the like according to the embodiment.

The sensor 50, for example, includes the RGB sensor for sensing the color of the lawn (for an example, green) in the present embodiment, but it is not limited thereto.

Or, the sensor 50 may include a spectrum sensor for sensing a spectrum for green lawn. In this case, the spectrum sensor irradiates specific light to distinguish the spectrum of the lawn, and recognizes the spectrum for the green section of the lawns from light to be reflected.

The sensor 50 may be disposed with the bottom of the body 10. In this case, The sensor 50 may be disposed toward the region having the lawn, that is, the ground.

The mowing device 40 is disposed in the body 10, and therefore, mows the lawns. The mowing device 40 is disposed in the bottom of the body 10, thereby to dispose toward the region having the lawn (hereinafter, refer to ‘the lawn presence region G’). When the mowing device 40 is driven by a controller 60, the lawns in the lawn presence region G are mowed.

The mowing device 40 may be implemented by a blade type, a reel type, a strand type formed with a cutter with rope, and other well-known cutter and the like.

The body 10 is disposed with the controller 60. The controller 60 controls all of the electronic/mechanical devices disposed in the lawn mower robot 1. The controller 160 controls the above-described moving device 20 and the mowing device 40, receives data sensed from the sensor 50 and the like, then, may store it into a memory 61, and may control the electronic/mechanical devices disposed in the lawn mower robot 1 based on the stored data.

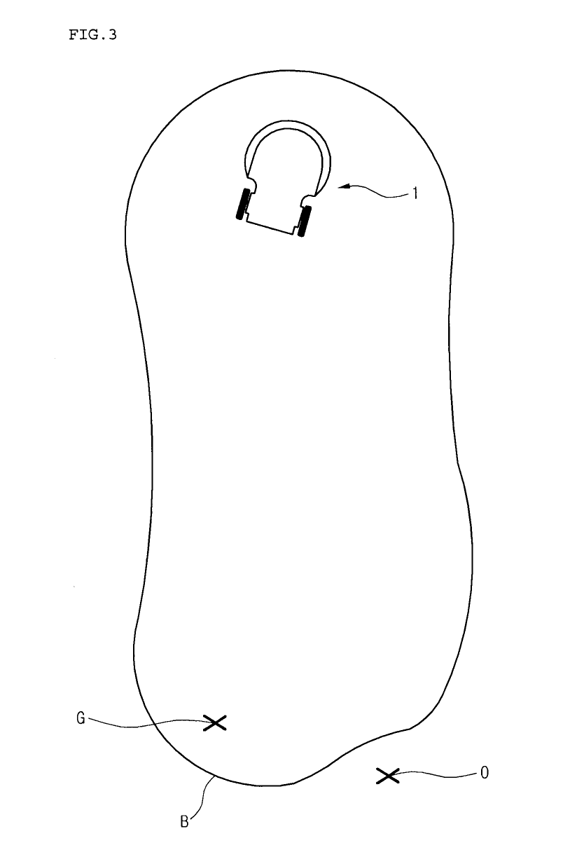

FIG. 3 is a view for the lawn mower robot 1 and the lawn presence area G according to the present embodiment.

Referring to FIG. 3, the lawn presence area G is defined as the region having the lawns as described above. The region having the lawn is generally partitioned into the lawn mowing region in a certain area to distinguish from different area in home or industrial environment. In this case, a boundary area B separates the lawn presence region G and the other remaining area O (refer to an outside region).

Some lawns may be present even on the other remaining region O having not the lawns, but, hereinafter, it is described that a lot of lawns are present in the lawn presence region G based on the boundary area B and the other remaining region O includes soil, concrete, block, road and the like having little lawn or plants.

The size of green data output from the sensor 50 is determined on the basis of the varieties of the lawns, the region in which the lawns live, seasonal state and the like to distinguish the lawn presence region G by the controller 60, and therefore, may be set to the controller 60 as reference value.

When the sensor 50 senses green boundary area B as which the lawn presence region G initially appears, the controller 60 maps the lawn presence region G based on data sensed by the sensor 50, and the mowing device 40 is driven in the lawn presence region G to mow the lawns. A controlling method that distinguishes the lawn presence region G by the controller 60 and stores it into a memory 61 will be described later.

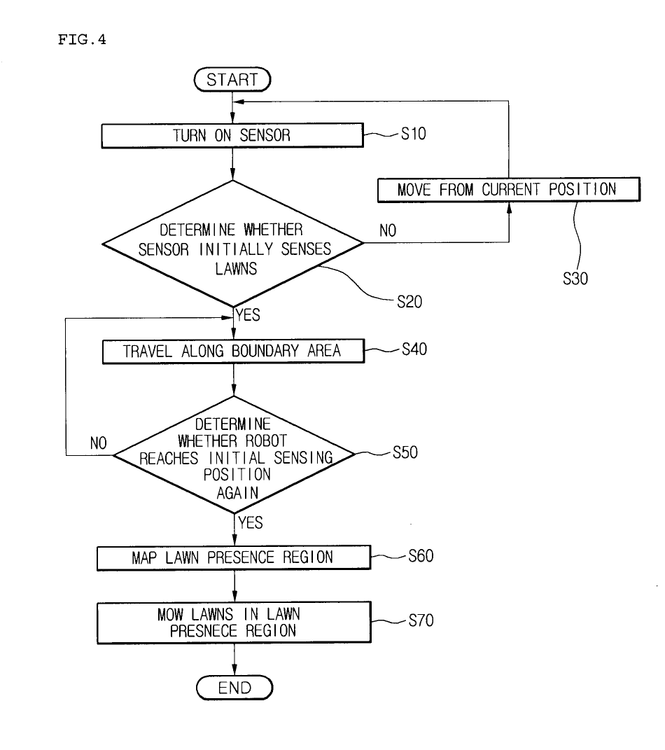

FIG. 4 is a flow chart for describing a method of controlling the lawn mower robot 1 according to the present embodiment.

Referring to FIGS. 3 and 4, the lawn mower robot 1 distinguishes the lawn presence region G, and the description for mowing the lawns in the lawn presence region G is performed.

First, the lawn mower robot 1 is disposed in a random region. In this state, the controller 60 allows the sensor 50 for sensing the green lawns to turn on (S10). The order for one for turning on the sensor 50 and one for disposing the lawn mower robot 1 in a random region will be fine even on reversing their order, and it is included in the spirit of the present embodiment.

Since then, the controller 60 drives the moving device 20 to move the lawn mower robot 1. On moving the lawn mower robot 1, the controller 60 determines whether the sensor 50 initially senses the lawns (S20). In the present embodiment, it is described that initially sensing the lawns means sensing the boundary area B initially.

That is, the sensor 50 is implemented by the RGB sensor or the spectrum sensor so as to sense the green lawns, and outputs the green data. Then, the controller 60 compares the initial set data with the green data output from the sensor 50 to determine whether the lawns are right.

The sensor 50 may sense the color except green from the region (outside region) not having the lawns on the basis of the boundary area B. The green and other color may be sensed from the region (outside region) not having the lawns on the basis of the boundary area B. However, the size of the green data output by the sensor 50 from outside region is smaller than that of the green data output by the sensor 50 on sensing the lawns in the lawn presence region G. Therefore, the controller 60 determines the lawn presence region G based on the result of the green data sensed by the sensor 50.

In this case, the size of the green data capable of being distinguished as the lawn presence region G may be set differently on the basis of the varieties of the lawns, the area in which the lawns live, seasonal state and the like.

When the lawn presence region G is determined, the boundary area B may be determined. Further, initial sensing position on initially sensing the boundary area B is stored into the memory.

On determining at step S20, in the case that the lawns are not sensed, the robot moves from a current position to a different position (S30).

When the lawns in the boundary area B are sensed, the controller 60 continuously drives the moving device 20, and therefore, allows the lawn mower robot 1 to travel along the boundary area B (S40). That is, the controller 60 continuously determines whether the boundary area B is right on the basis of the green data output from the sensor 50 to allow the lawn mower robot 1 to travel along the boundary area B. Further, the positions of the boundary area B to be persistently sensed are stored into the memory 61.

When the lawn mower robot 1 travels along the boundary area B, the controller 60 drives the mowing device 40 to mow the lawns in the boundary area B. In this case, the boundary area B of the lawn presence region G may be edge-trimmed.

When the lawn mower robot 1 travels along the boundary area B, the controller determines whether the robot 1 reaches the initial sensing position again (S50). On determining at step S50, when the robot 1 reaches the initial sensing position, a closed region is completed such that it is stored into the memory 61. The stored closed region becomes the lawn presence region G, thereby to map the lawn presence region G (S60).

When the mapping of the lawn presence region G is ended, the robot 1 mows the lawns using the mowing device 40 while moving in the lawn presence region G (S70).

According to an embodiment of the present invention, the lawn mower robot automatically senses the lawn presence region and automatically mows the lawns such that it is unnecessary to manually mow the lawns.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A lawn mower robot, comprising:
a body disposed with a moving device;
a mowing device disposed at the bottom of the body and mowing lawns;
a sensor disposed at the body and outputting data by sensing colors; and
a controller that determines a lawn presence region based on data output from the sensor.

2. The lawn mower robot according to claim 1, wherein the sensor senses the colors of objects positioned under the body.

3. The lawn mower robot according to claim 1, wherein the sensor includes a RGB sensor.

4. The lawn mower robot according to claim 1, wherein the sensor is a spectrum sensor for sensing spectrum of green lawns.

5. The lawn mower robot according to claim 1, further comprising a memory for storing reference values for green data,
wherein the controller compares the reference values stored in the memory with the green data output from the sensor to determine a boundary area for determining the lawn presence region.

6. The lawn mower robot according to claim 5, wherein the boundary area determined by the controller is stored into the memory.

7. The lawn mower robot according to claim 6, wherein when the controller determines that the body returns the boundary area initially sensed among the boundary areas stored into the memory, it determines the lawn presence region based on the boundary area stored into the memory, and controls the moving device and the mowing device to perform mowing in the determined lawn presence region.

8. The lawn mower robot according to claim 5, wherein on determining the boundary area, the controller drives the mowing device to mow the lawns in the boundary area.

9. A method of controlling a lawn mower robot, comprising:
determining a boundary area for determining a lawn presence region based on color information sensed from a sensor on moving the lawn mower robot;
determining the lawn presence region based on the determined boundary area when being determined that the lawn mower robot reaches the boundary area to be initially determined on moving the lawn mower robot; and
mowing lawns while moving the lawn mower robot in the determined lawn presence region.

10. The method according to claim 9, further comprising, when the boundary area is determined, mowing the lawns in the determined boundary area by driving a mowing device.
